(19) United States
(12) Patent Application Publication
(10) Pub. No.: US 2010/0305842 A1
(43) Pub. Date: Dec. 2, 2010

(54) METHOD AND APPARATUS TO FILTER AND DISPLAY ONLY POIs CLOSEST TO A ROUTE

(75) Inventor: Kyte Feng, Los Angeles, CA (US)

Correspondence Address: Alpine Electronics of America, Inc., 19145 Gramercy Pl., Torrance, CA, 90503, US

(73) Assignee: Alpine Electronics, Inc., Torrance, CA (US)

(21) Appl. No.: 12/472,558

(22) Filed: May 27, 2009

(51) Int. Cl. G01C 21/36; G06F 17/30

(52) U.S. Cl. 701/201; 707/E17.044; 707/E17.018

(57) ABSTRACT

This invention relates to an apparatus and a method to display Points-of-Interest (POIs) in a navigation system. More specifically, this invention relates to a navigation-based apparatus and method adapted to filter redundant POIs and display only the POIs closest to the route. In one aspect, the POI display apparatus in the navigation system includes a user interface to display maps and POI information, an information receiver adapted to receive a current location of a user, at least one database to store maps, road networks and POI information, a route generating unit to retrieve the map and road network data from the database and generate a calculated route, a POI searching unit to search POIs in a predetermined searching range and searching distance and a POI filtering unit to divide the POIs discovered by the searching unit into different categories, group the POIs with the same names in each category and sort the POIs in each group according to the distance from the calculated route. In one embodiment, the POI information can be transmitted to the navigation from a remote server or communication networks.

### FIELD OF THE INVENTION

This invention relates to an apparatus and a method to display Points-of-Interest (POIs) in a navigation system. More specifically, this invention relates to a navigation-based apparatus and method adapted to filter redundant POIs and display only the POIs closest to the route.

### BACKGROUND OF THE INVENTION

Navigation devices, including portable navigation devices (PNDs), have become more popular and affordable recently for most users. The navigation device can, not only determine the driver's current position by utilizing the Global Positioning System (GPS), but also provide different routing information between the vehicle's current position and the destination. In order to perform abovementioned functions, the navigation device is usually equipped with a sophisticated navigation system comprising navigation computer programs and one or more detailed database to store and provide maps, road networks, geographical features, and waypoint or point-of-interest (POI) information.

Generally, the navigation system generates a preferred or optimized route after receiving destination information input by the driver and displays the route on a display unit. The user may need some POI information along the route available, such as a gas station, restaurant, hotel, etc. when the user is traveling for a relatively long distance. Under these circumstances, the navigation system has been developed to display POI information in a more concisely and clearly manner to the user.

U.S. Pat. No. 7,480,566 to Laverty discloses a search method and apparatus for a navigation system finding accessible POIs along the route to the destination in a flexible manner. Furthermore, Laverty discloses the navigation system that can vary its search range when it determines that the geographic condition warrants expansion of the search range along the calculated route. As can be seen in FIG. 1, when the navigation system detects an intersection formed by a calculated route 101 and a cross street 105a, the navigation system will expand the search circle 133 to a predetermined distance along the cross street 105a. However, Laverty does not disclose how to filter out redundant POIs with the same names and only display POIs closest to the route with different names.

U.S. Pat. No. 7,272,489 to Tu discloses a navigation method and system for extracting point of interest (POI) data from a map data source and sorting the POIs by distance from a current user position to display the same at high speed without requiring a large memory. More specifically, Tu discloses the navigation system aligning each cell having a specified POI 210 (shown in FIG. 2) in a cell array 220 in FIG. 2a and classifying the cells into a plurality of different levels based on distance (first sorting operation 230 shown in FIG. 2b) from the current user position, or positions of the cells in the cell array relative to the cell closest to the user position. The navigation system extracts the POIs from the cells 220 in the specified level, sorts the POIs by distance (second sorting operation 240 shown in FIG. 2c), and displays the POIs. Like Laverty, Tu does not disclose how to filter out redundant POIs with the same names and only display POIs closest to the route with different names.

U.S. Pat. No. 6,009,403 to Sato discloses a travel plan preparing device used for preparing a travel plan by accessing a data base from terminal and acquiring information about service facilities existing on the route from the starting place to the destination. Like Laverty and Tu, Sato does not teach anything related to filter out redundant POIs with the same names and only display POIs closest to the route with different names.

Therefore, there remains a need for a new and improved POI displaying system and method for which filters out redundant POIs and only displays the POIs closest to the calculated route with different names.

### SUMMARY OF THE INVENTION

It is an object of the present invention to provide a Point-of-Interest (POI) displaying method and apparatus in a navigation system filtering out redundant POIs which appear more than once along at least a portion of a calculated route.

It is another object of the present invention to provide a clear and concise way to display POIs, so that the user has better understanding of the POIs closest to at least a portion of the calculated route.

It is another object of the present invention to reduce POI clutter on the screen by eliminating POIs which are too far away from the calculated route.

It is still another object of the present invention that the POI information can not only retrieve from an on-board database, but also from an off-board server or communication networks.

It is a further object of the present invention that the navigation system is adapted conduct POI search repeatedly in a predetermined searching distance and a predetermined searching range along the calculated route until the user reach the destination.

It is still a further object of the present invention to provide a simple and concise POIs display method and apparatus which can be used in a mapless navigation system.

According to one aspect of the present invention, a POI display apparatus in the navigation system comprises a user interface; an information receiver adapted to receive information about current location of the user, for example, from a global positioning system (GPS); at least one database to store and provide maps, road networks, geographical features and POI information; a route generating unit to retrieve the map and road network data from the database and generate a calculated route; and a POI searching unit adapted to search POIs in a predetermined searching range and a predetermined searching distance according to the current position of the user at the calculated route. In one embodiment, the user interface is a display unit which is configured to display maps, POIs and routing information. In another embodiment, the navigation system may be portable.

In another embodiment shown in FIG. 4, the POI searching unit is communicatively coupled with the route generating unit to repeatedly conduct POI search in a predetermined searching distance D according to the user's current location on the calculated route. For example, the searching unit may conduct POI search for restaurants every twenty miles along the route until the driver reaches the destination. In addition, the searching range R can be defined as a searching scope extended from the calculated route, within which the searching unit can retrieve the POI information. In another embodiment, the searching range R can be determined by the driver based on the driver's need. In still another embodiment, the searching range R can be determined by the navigation system according to the driver's profile retrieved from at least one remote server. For example, if the navigation system's default searching range is one mile and the system receives the driver's profile from the remote server, illustrating that the driver likes McDonalds, the system may modify the searching range R from one to two miles for McDonalds. In still another embodiment, the searching range R can also be modified based on the recommendations from the driver's social networking websites, such as Zagat, Yelp, Facebook, Twitter, etc.

In a further embodiment, the POI information can be transmitted to the navigation system from a POI information server, the Internet or other communication networks, such that the driver is able to receive the most current POI information along the route.

In still a further embodiment, the present invention can be used in a mapless navigation system, wherein the navigation system provides a cost-efficient navigational assistance to the driver without utilizing so called “map matching” technology. In the mapless navigation system, a radio display panel is usually used as the display unit, which is much smaller than that in regular navigation systems. Thus, displaying only POIs closest to the calculated route is particularly important to the mapless navigation system to efficiently use the space of the limited radio display panel.

The navigation system may also include a POI filtering unit which is programmed to divide the POIs discovered by the searching unit into different categories, group the POIs with the same names in each category and sort the POIs in each group according to the distance from the calculated route. The display unit is then adapted to display the POI in each group which is closest to the calculated route.

In another aspect, a method for filtering redundant POIs and only displaying POIs closest to the route includes the steps of: retrieving road network data, map data and geographical features, and POI information from at least one database; generating a calculated route based on a current user position and a destination input by the user; searching POIs in a predetermined searching distance and a predetermined searching range according to the position of the user at the calculated route; and displaying POIs closest to said calculated route.

In one embodiment, the step of retrieving at least one road network data, map data and geographical features, and POI information from at least one database includes the step of receiving POI information from the on-board database. In another embodiment, the POI information may be retrieved from a remote server, the Internet or other communication networks. Furthermore, the POI information may be retrieved from the driver's social networking websites, such as Zagat, Yelp, Facebook, etc.

In the method of the present invention, the step of searching POIs in a predetermined searching distance and a predetermined searching range includes a step of repeatedly searching POIs in the searching distance according to the user's current position at the calculated route. In one embodiment, the searching range can be modified by the driver. In another embodiment, the searching range can be modified by the navigation system based on the driver's profile retrieved from at least one off-board server.

The step of displaying POIs closest to said calculated route includes the step of filtering the POIs which may include the step of dividing the POIs into different categories, grouping the POIs with the same names in each category and sorting the POIs in each group according to the distance from the calculated route.

The present invention together with the above and other advantages may best be understood from the following detailed description of the embodiments of the invention illustrated in the drawings below.

### BRIEF DESCRIPTION OF THE DRAWINGS

FIG. 1 illustrates a prior art, related to a navigation system finding accessible POIs along the route to the destination in a flexible manner.

FIGS. 2, 2a-2c illustrates a prior art, related to a navigation system extracting point of interest (POI) data from a map data source and sorting the POIs by distance from a current user position to display the same at high speed without requiring a large memory.

FIG. 3 illustrates a functional block diagram showing an example of structure of a navigation system implementing the method and apparatus to filter redundant POIs and display only the POIs closest to the calculated route in the present invention.

FIG. 4 illustrates a regular POI display on a map before filtering redundant POIs.

FIGS. 4a-4c illustrate one embodiment in the present invention to divide the POIs into different categories, group the POIs with the same names in each category and sort the POIs in each group according to the distance from the calculated route.

FIG. 4d illustrates one embodiment in the present invention which only displays the POIs closest to the calculated route.

FIGS. 4e and 4f illustrates another embodiment in the present invention which only displays the POIs closest to the calculated route.

FIG. 5 illustrates a schematic view of receiving POI information or driver profile from a remote server, a network server or the Internet via a communication network.

FIG. 6 depicts a method for filtering redundant POIs and only displaying POIs closest to the calculated route in the present invention.

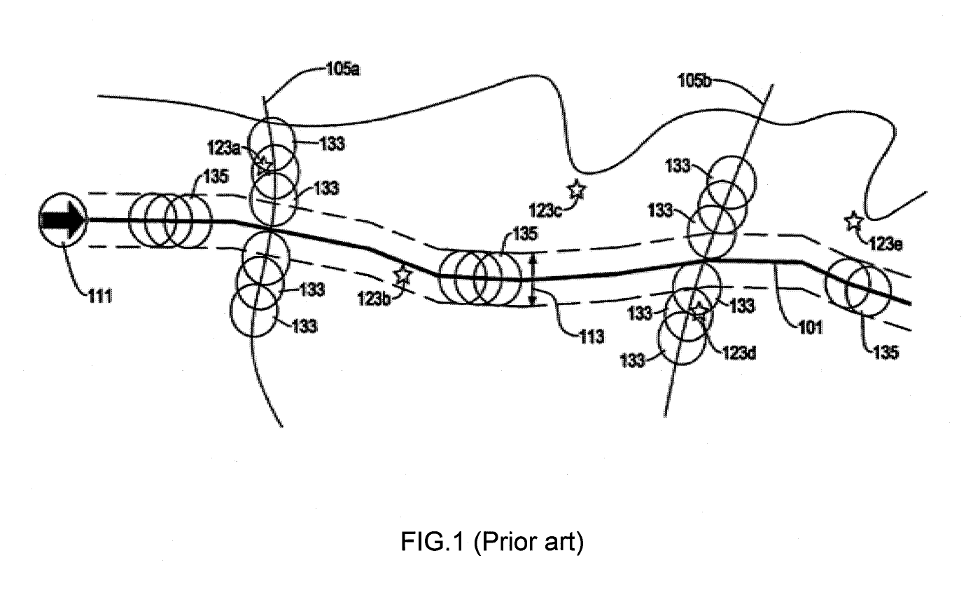

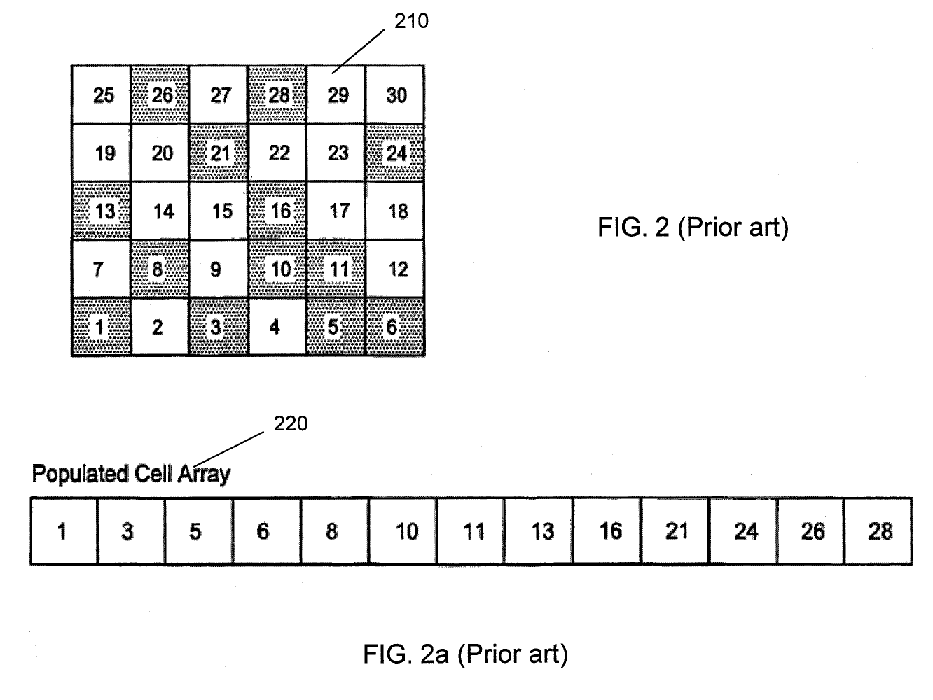

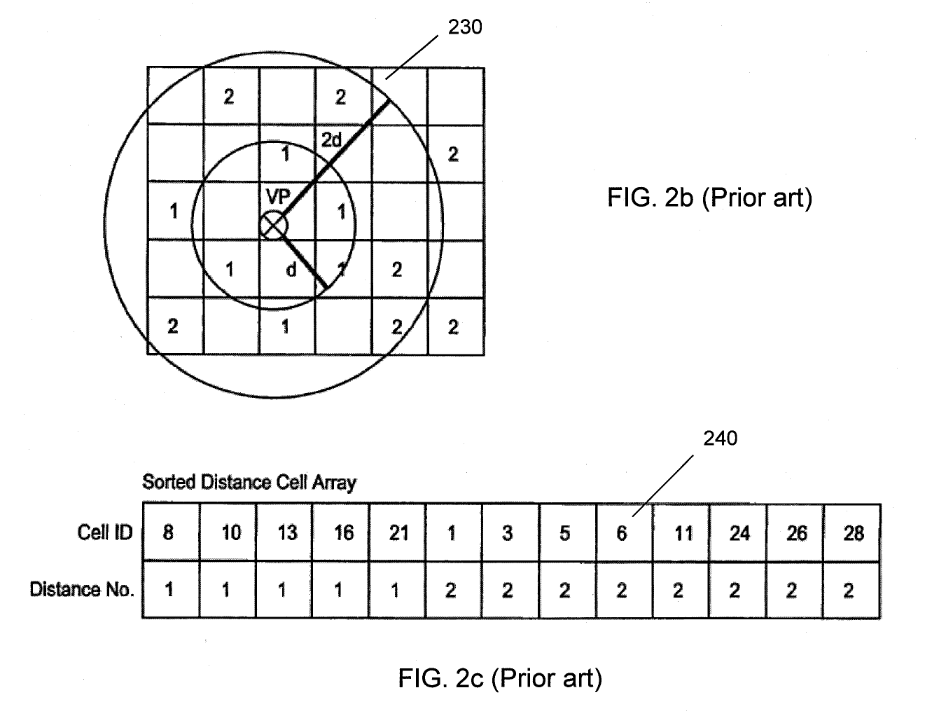

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

The present invention relates to an apparatus and a method to display Points-of-Interest (POIs) in a navigation system. More specifically, this invention relates to a navigation-based apparatus and method adapted to filter redundant POIs and display only the POIs closest to the route. This invention is particularly important when utilizing in a mapless navigation system in which a radio display panel is usually used as a display unit and the space to display navigational information is thus limited. Under such circumstances, displaying only POIs closest to the calculated route provides an efficient way to use the limited space of the radio display panel. Furthermore, the POI information can be retrieved from either an on-board or off-board database, such that a user may be able to receive most current POI information along the route.

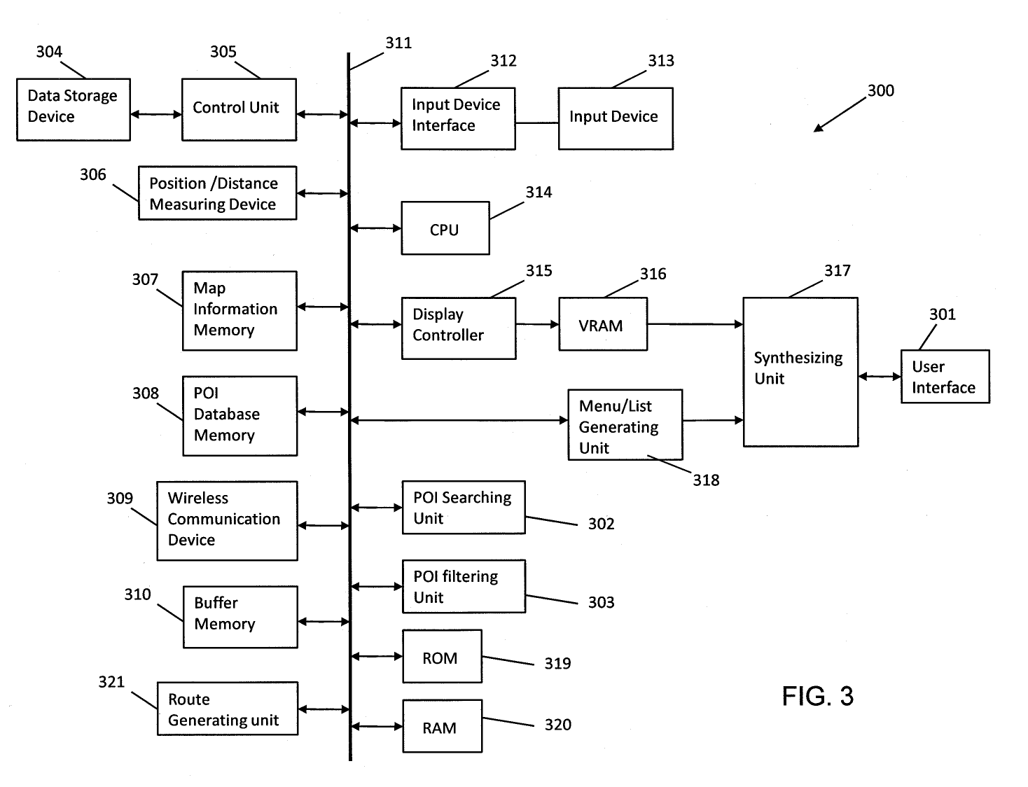

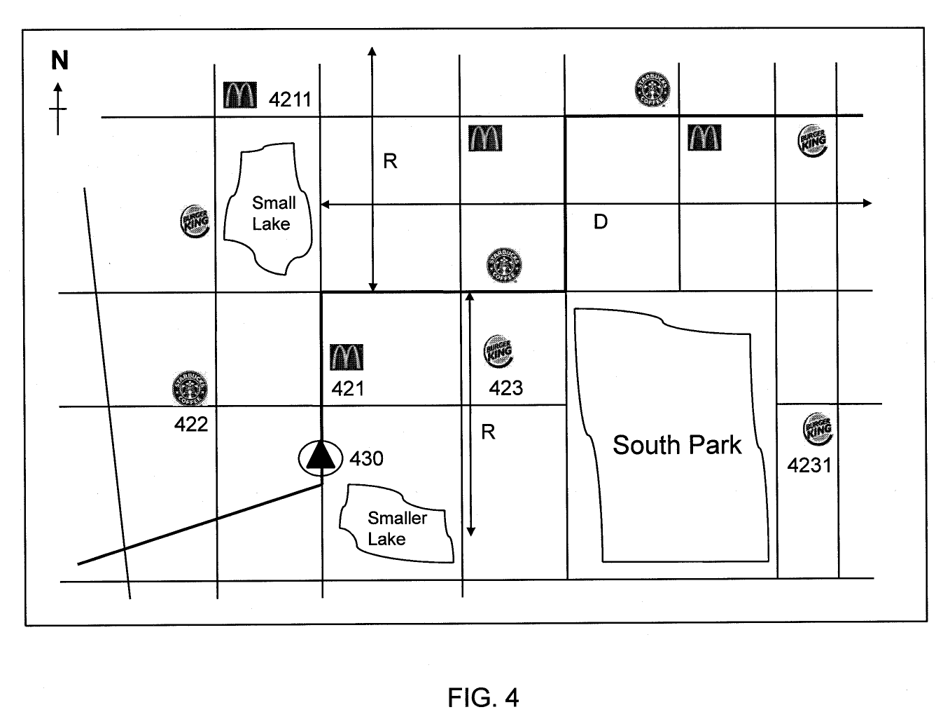

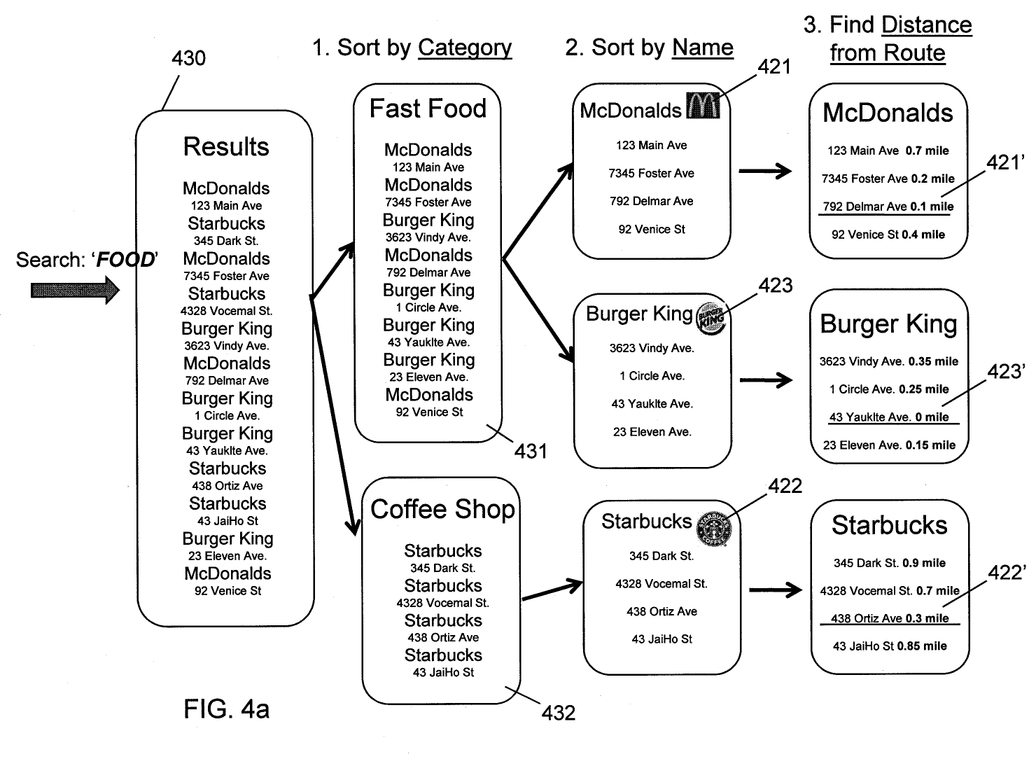

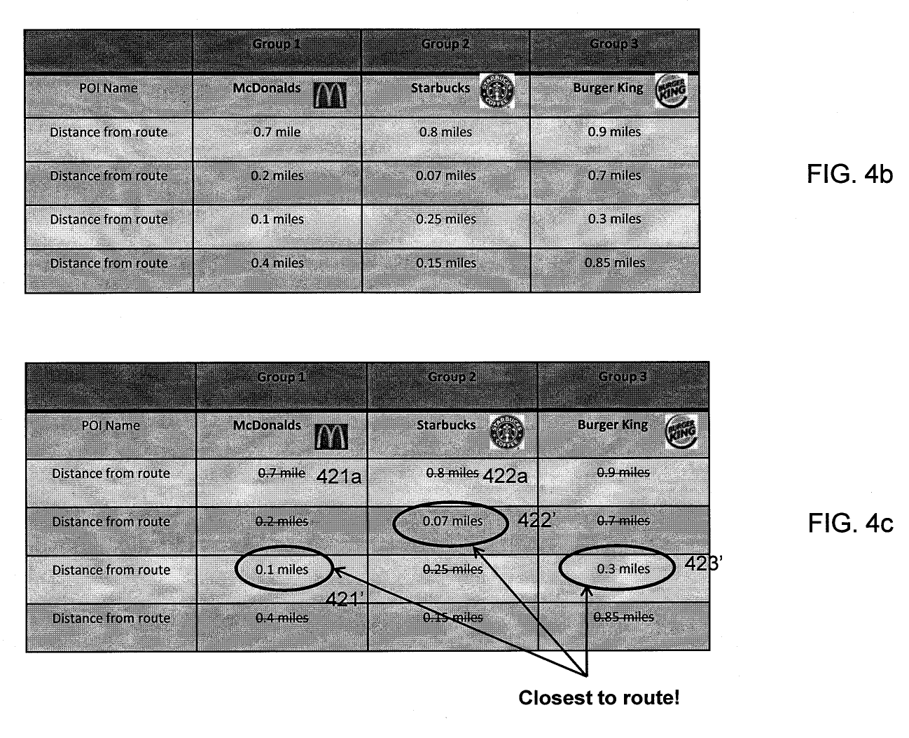

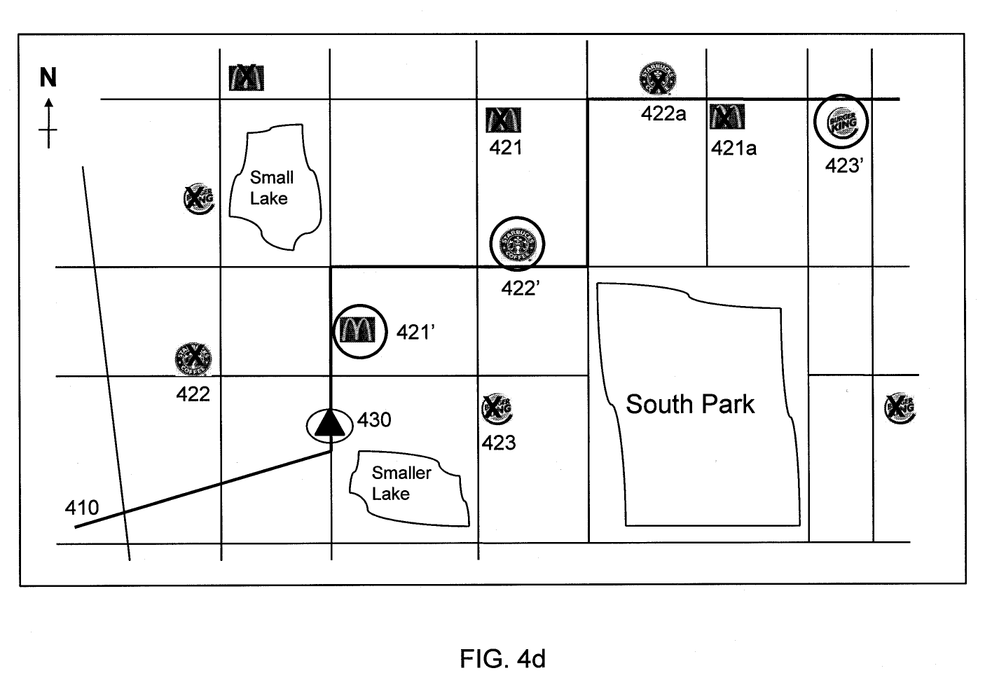

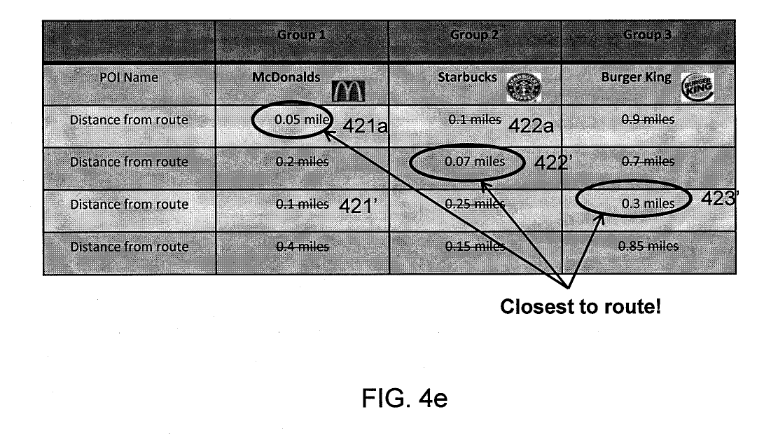

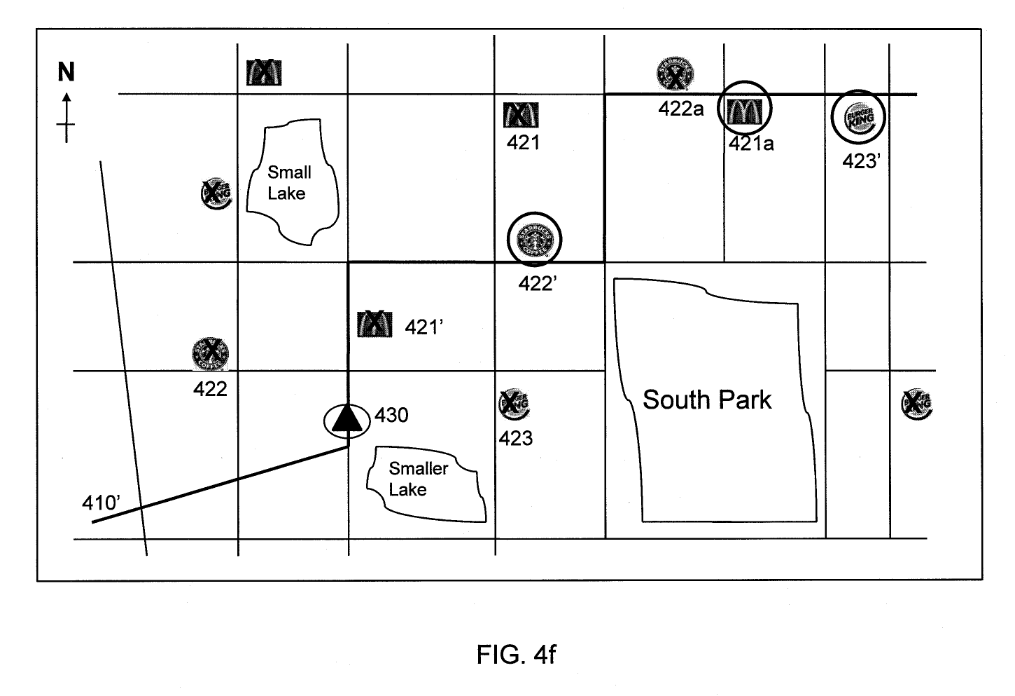

FIG. 3 is a block diagram showing an example of structure of a navigation system 300 for implementing the present invention. The navigation system 300 includes a user interface 301, a route generating unit 321 to retrieve map and road network data and generate a calculated route, a POI searching unit 302 adapted to search POIs in a predetermined searching distance D and a predetermined searching range R according to the user's current location 430 at the calculated route 410, as can be seen in FIG. 4. In one embodiment, the user interface is a display unit which is configured to display maps, POIs and routing information. In another embodiment, the searching unit 302 is communicatively coupled with the route generating unit 321 to repeatedly conduct POI search in the predetermined searching distance D according to the user's current location 430 at the calculated route 410. For example, the searching unit 302 may conduct POI search for restaurants every twenty miles along the route 410 until the driver reaches the destination. Moreover, the predetermined searching range R can be determined based on the user's profile stored in an on-board database. For example, if the navigation system's default POI searching range is one mile and the navigation system 300 receives the driver's profile from the on-board database that the driver likes McDonalds, the system 300 may modify the searching range R from one to two miles for McDonalds. In another embodiment, the searching unit 302 may retrieve the driver's profile from a remote server by coupling with a wireless communication device 309. In still another embodiment, the searching range R can also be modified based on the recommendations from the user's social networking websites, such as Facebook, My Space, Twitter, etc.

The system also includes a data storage device 304 such as a hard disc, CD-ROM, DVD or other storage means for storing the map data; a control unit 305 for controlling an operation for reading the information from the data storage device 304; and a position and distance measuring device 306 for measuring the present vehicle position or user position. For example, the position and distance measuring device 306 has a speed sensor for detecting a moving distance, a gyroscope for detecting a moving direction, a microprocessor for calculating a position, a GPS (global positioning system) receiver for receiving GPS signals from satellites for calculating a current position of the user. In one embodiment, the POI searching unit 302 is communicatively coupled with the position and distance measuring device 306 to receive the current position of the user. In another embodiment, the navigation system 300 may be portable.

The block diagram of FIG. 3 further includes a map information memory 307 for storing the map information which is read from data storage 304, a database memory 308 for storing database information such a point of interest (POI) information which is read out from the data storage device 304, an input device 313 for executing a menu selection operation, an enlarge/reduce operation, a destination input operation, . . . etc. and an input device interface 312. In one embodiment, the input device 313 is a remote controller.

Still referring to FIG. 3, the navigation system 300 includes a bus 311 for interfacing the above units in the system, a processor (CPU) 314 for controlling an overall operation of the navigation system 300, a ROM 319 for storing various control programs such as a route search program and a map matching program necessary for navigation control, a RAM 320 for storing a processing result such as a guide route, a display controller 315 for generating map image (a map guide image and an arrow guide image) on the basis of the map information, a VRAM 316 for storing images generated by the display controller 315, a menu/list generating unit 318 for generating menu image/various list images, a synthesizing unit 317, a wireless communication device 309 to retrieve data from a remote server, the Internet or other communication networks, and a buffer memory 310 for temporary storing data for ease of data processing.

In one embodiment, the POI searching unit 302 can retrieve the POI information from the POI Database Memory 308. In another embodiment, the POI searching unit 302 can be communicatively coupled with the wireless communication device 309 to retrieve the POI information from the remote server, the Internet or other communication networks, such that the driver is able to receive the most current POI information along the route 410.

The navigation system 300 may also include a POI filtering unit 303 which is configured to divide the POIs discovered by the searching unit 302 into different categories, group the POIs with the same names in each category and sort the POIs in each group according to the distance from the calculated route generated by the route generating unit 321. The user interface 301 is then adapted to display the POI in each group which is closest to the calculated route 410.

Referring to FIG. 4, without the POI filtering unit 303, when the driver tries to search by using the keyword “food,” the searching unit 302 starts to search POIs in a predetermined searching range and a predetermined searching distance according to the user's current position 430 at the calculated route 410. As can be seen in FIG. 4, some identical POI icons close to the calculated route 410 are shown in the user interface 301 and the driver may be confused if there are too many POI icons clustering thereon. Furthermore, it may be impractical for the driver to driver to some POIs which may be far away from the calculated route 410, such as POIs 4211 and 4231. Also, if the space for the user interface 301 is limited, such as a mapless navigation system, it is advantageous to display only the POIs closest to the calculated route 410.

As mentioned above, the POI filtering unit 303 is configured to divide the POIs discovered by the searching unit 302 into different categories, group the POIs with the same names in each category and sort the POIs in each group according to the distance from the calculated route. The user interface 301 is then adapted to display the POI in each group which is closest to the calculated route 410. As can be seen in FIG. 4a, once the POI searching unit 302 retrieves a preliminary searching result 430 according to the keyword, e.g., food, the POI filtering unit 303 divided the POIs into two categories, Fast food 431 and Coffee Shop 432. The POI filtering unit 303 can further divide each category based on the POI names therein. For example, in the category of Fast food 431, the POIs can be further divided into different groups by names, such as “McDonalds” 421 and “Burger King” 423, as well as “Starbucks” 422 in the category of Coffee Shop 432.

Moreover, the POI filtering unit 303 retrieves location information of each POI from the POI Database Memory 308 and calculates the distances between each POI and the calculated route 410 as shown in FIG. 4b. In one embodiment, if the calculated route 410 is a freeway or highway with a plurality of exits, even though some POIs seems to be the closest ones to the route 410, the driver may have to drive further to the next exit to access those POIs. For example, if POIs 421a and 422a are not right next to the freeway exit, even though the POIs 421a and 422a seem to be as close as the POIs 421′ and 422′ on the FIG. 4d, the driver may have to drive further to the exit where the POI 423′ is located and turn around to the POIs 421a and 422a. Under such circumstances, the additional driving distance may be considered in the present invention. More specifically, as can be seen in FIG. 4c, the driver has to drive 0.7 and 0.8 miles from the closest exit to the POIs 421a and 422a, respectively; whereas the driver can access the POIs 421′ and 422′ with the shortest driving distance (0.1 and 0.07 miles, respectively).

In another embodiment, if the calculated route 410′ is a surface road, the distances shown in FIG. 4e reflect actual distances from the POIs to the calculated route 410. As can be seen in FIGS. 4e and 4f, the result for filtering and displaying the POIs closest to the route may be different from FIGS. 4c and 4d.

Finally, as shown in both FIGS. 4d and 4f, the POI closest to the calculated route 410 in each group is filtered and shown on the user interface 301, such as the POIs 421′, 422′, 423′ in FIG. 4d and 421a, 422′, 423 in FIG. 4f. In other words, each POI with a “red cross” in FIGS. 4d and 4f will not be shown on the user interface 301 after the filtering process in the present invention.

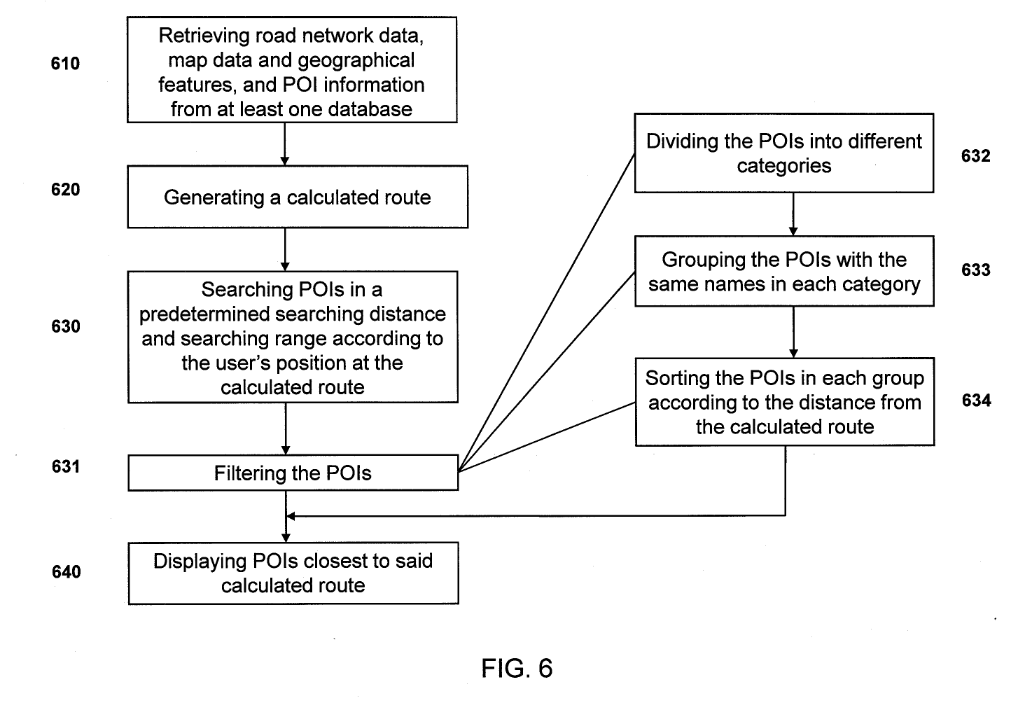

A program for conducting the operation of POI displaying in the present invention shown in the flow charts of FIG. 6 is stored in the ROM 319 or other memory and is executed by the CPU 314. The CPU 314 controls an overall operation of the navigation system including the method and apparatus to filter and display only the POIs closest to the route in the present invention.

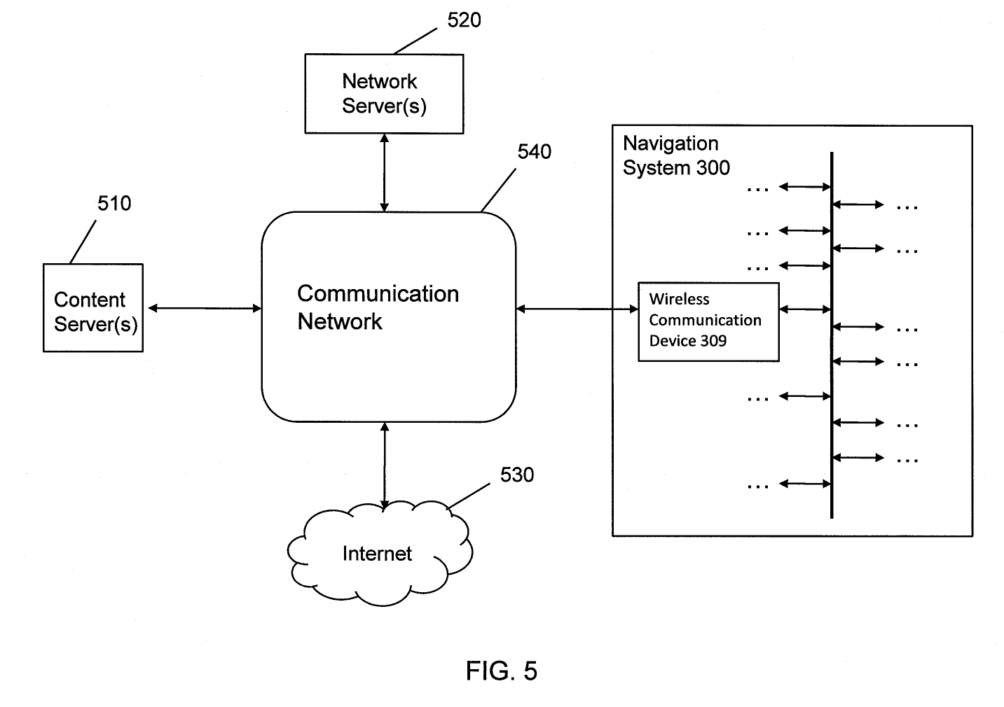

As mentioned above, the POI information can be transmitted to the navigation system 300 from a remote server, the Internet or other communication networks. More specifically, as depicted in FIG. 5, the wireless communication device 309 in the navigation system 300 is adapted to receive the POI information from a communication network 540, which connects to, but not limited to, a content server 510, a network server 520, and the Internet 530. In one embodiment, a plurality of content servers 510 may be provided to store different contents, including POI information. In one embodiment, the network server 520 is adapted to receive information from some network subscribers and share the information with at least portion of the network subscribers via the communication network 540. For example, the network server 520 may receive traffic information from some subscribers stuck in traffic in Freeway 405 and share this traffic information with other subscribers to avoid using Freeway 405. Similarly, the network server 520 may receive POI information recommended by some subscribers and share the information via the communication network 540 to the wireless communication device 309 in the navigation system 300 in the present invention.

In another embodiment, the POI information may be received from the Internet 530. For example, if the user is looking for restaurants while driving along the route, the restaurant information may be received from websites such as Zagat, Yelp, Facebook, Twitter, etc. and transmitted via the communication network 540 to the navigation system 300 in the present invention, such that the user may be able to receive the most current POI information along the route.

According to another aspect of the present invention in FIG. 6, a method of filtering redundant POIs and only displaying POIs closest to the route includes the steps of: retrieving road network data, map data and geographical features, and POI information from at least one database 610; generating a calculated route based on a current user position and a destination input by the user 620; searching POIs in a predetermined searching distance and a predetermined searching range according to the user's position at the calculated route 630; and displaying at least a portion of said POIs which are closest to said calculated route 640. The method in the present invention may include the step of filtering the POIs 631 which may include the step of dividing the POIs into different categories 632, grouping the POIs with the same names in each category 633 and sorting the POIs in each group according to the distance from the calculated route 634.

In one embodiment, the step of retrieving at least one road network data, map data and geographical features, and POI information from at least one database 610 includes the step of receiving POI information from the on-board database, such as Map Information Memory 307, POI Database Memory 308, Buffer Memory 310, or the like. In another embodiment, as illustrated above in FIG. 5, the POI information can be retrieved from the “off-board” database, such as the content server 510, network server 520, or the Internet 530 via the communication network 540. In step 620, the position and distance measuring device 306 in the present invention is adapted to receive the user's current position, and the route generating unit 321 can generate the calculated route based on the information received from step 610.

In one embodiment, the POI searching unit 302 is adapted to search POIs in a predetermined searching distance D and searching range R, as shown in FIG. 4, in step 630. In another embodiment, the POI searching unit 302 may repeatedly search POIs in the predetermined searching distance D according to the user's current position 430 at the calculated route 410. For example, the searching distance D can be twenty miles ahead the user's current position 430 and the searching range R can be one mile from the calculated route 410. In one embodiment, the driver can modify the searching distance D and searching range R. In another embodiment, the searching range R may be modified by the navigation system 300 based on the driver's profile stored in the on-board database or in the network server 520.

In a further embodiment, the POI filtering unit 303 is configured to filter the POIs in step 631. More specifically, the POI filtering unit 303 is adapted to divide the POIs into different categories in step 632, group the POIs with the same names in each category in step 633 and sort the POIs in each group according to the distance from the calculated route in step 634. The user interface is then adapted to display the POI in each group which is closest to the calculated route 410 in step 640.

Having described the invention by the description and illustrations above, it should be understood that these are exemplary of the invention and are not to be considered as limiting. Accordingly, the invention is not to be considered as limited by the foregoing description, but includes any equivalents.

1. A navigation system comprises:
a user interface;
an information receiver adapted to receive information about current location of a user;
at least one database to store and provide maps, road networks, geographical features, and point-of-interest (POI) information;
a route generating unit to retrieve the map and road network data from the database and generate a calculated route; and
a POI searching unit adapted to search POIs in a predetermined searching range and a predetermined searching distance according to user's current position at the calculated route,
wherein the user interface is configured to display POIs with different names which are closest to said calculated route.

2. The navigation system of claim 1, wherein the POI searching unit is communicatively coupled with the route generating unit to repeatedly conduct POI search in a predetermined searching distance ahead from the user's current position.

3. The navigation system of claim 1, wherein the database is a memory device in said navigation system, or a remote server, the Internet or other communication networks, which are adapted to transmit POI information to said navigation system.

4. The navigation system of claim 1 further comprises a POI filtering unit which is programmed to divide the POIs discovered by the POI searching unit into different categories, group the POIs with the same names in each category, and sort the POIs in each group according to a distance from the calculated route, wherein the user interface is adapted to display only the POIs closest to the calculated route in each group.

5. The navigation system of claim 1, wherein the predetermined searching distance and searching range are determined by the user or by said navigation system according to the driver's profile retrieved from at least one remote server.

6. The navigation system of claim 4, wherein the distance from the calculated route is measured from a closest exit to the POIs when the calculated route is a freeway or highway.

7. A method of filtering redundant POIs and only displaying POIs closest to a route comprises the steps of:
retrieving road network data, map data and geographical features, and POI information from at least one database;
generating a calculated route based on current position of a user and a destination input by a driver;
searching said POIs in a predetermined searching distance and a predetermined searching range according to the user's position and the calculated route; and
displaying at least a portion of said POIs which are closest to said calculated route.

8. The method of claim 7, wherein the step of retrieving POI information from at least one database comprises the step of retrieving POI information from at least one on-board or off-board database.

9. The method of claim 7, wherein the step of searching said POIs in a predetermined searching distance and a predetermined searching range comprises a step of repeatedly searching POIs in the predetermined searching distance according to the user's current position at the calculated route.

10. The method of claim 9, wherein the step of comprises a step of determining said searching range according to the driver's profile store in at least one on-board or off-board database.

11. The method of claim 7, further comprises a step of filtering said POIs including the steps of dividing the POIs into different categories, grouping the POIs with the same names in each category and sorting the POIs in each group according to the distance from the calculated route.

12. The method of claim 11, wherein the step of sorting the POIs in each group according to the distance from the calculated route comprises a step of measuring the distance from a closest exit to the POIs when the calculated route is a highway or freeway.

13. An apparatus for displaying POIs closest to a route comprises:
a display unit;
a position measuring unit to provide a user's current position;
a route generating unit to generate the route; and
a POI searching unit adapted to search POI information in a predetermined searching range and a predetermined searching distance according to current the user's current position at the calculated route,
wherein the POIs retrieved by said searching unit are further divided into different categories, grouped with the same POI names in each category and sorted according to a distance from the route in each group, and the POIs from each different groups which are closest to the route are displayed on the display unit.

14. The apparatus of claim 13, wherein the POI searching unit is communicatively coupled with the route generating unit to repeatedly conduct POI search in a predetermined searching distance ahead from the user's current position.

15. The apparatus of claim 13, wherein the POI information is stored in at least one on-board database or off-board database.

16. The apparatus of claim 13, wherein the predetermined searching distance and searching range are determined by the user or by said navigation system according to the driver's profile retrieved from at least one remote server.

17. A mapless navigation system comprises:
a user interface;
a position measuring unit to provide a user's current position;
a route generating unit to generate the route; and
a POI searching unit adapted to search POI information in a predetermined searching range and a predetermined searching distance according to current the user's current position and the calculated route,
wherein the POIs retrieved by said searching unit are further divided into different categories, grouped with the same POI names in each category and sorted according to a distance from the route in each group, and different POIs which are closest to the route are displayed on the user interface.

18. The mapless navigation system of claim 17, wherein the POI searching unit is communicatively coupled with the route generating unit to repeatedly conduct POI search in a predetermined searching distance ahead from the user's current position.

19. The mapless navigation system of claim 17, wherein the POI information is stored in at least one on-board database or off-board database.

20. The mapless navigation system of claim 17, wherein the predetermined searching range is determined by the user or by said navigation system according to the driver's profile retrieved from at least one remote server.
